(19) United States
(12) Patent Application Publication
(10) Pub. No.: US 2024/0061895 A1
(43) Pub. Date: Feb. 22, 2024

(54) MULTIPARTY CONVERSATIONAL SEARCH AND CURATION

(71) Applicant: AT&T Intellectual Property I, L.P., Atlanta, GA (US)

(72) Inventors: Nigel Bradley, Canton, GA (US); Eric Zavesky, Austin, TX (US); James Pratt, Round Rock, TX (US); Ari Craine, Marietta, GA (US); Robert Koch, Peachtree Corners, GA (US)

(21) Appl. No.: 17/820,344

(22) Filed: Aug. 17, 2022

(51) Int. Cl. G06F 16/9535; G06F 16/332; G06F 16/338

(52) U.S. Cl. CPC G06F 16/9535; G06F 16/3325; G06F 16/338

(57) ABSTRACT

The disclosed technology is directed towards obtaining a search query by monitoring a user group's communications, and presenting search results to the user group. A conversation thread is inferred by a system, e.g., a conversational search server of a cloud based system. The conversational search server determines a search query relevant to the conversation thread, and communicates with a search engine or the like to obtain search result data. The search result data is presented on devices of the users of the group, e.g., via a virtual agent. Search queries can be altered as a conversation progresses to provide updated and/or filtered results. For example, broad results can be narrowed as more information is obtained by the system as a conversation progresses. Search results can be interactive, such as to obtain more information for a result, or to obtain a consensus as to what the majority of a group selects.

### TECHNICAL FIELD

The subject application relates to the presentation of information in general, and more particularly to presenting information in association with a conversation, and related embodiments.

### BACKGROUND

Contemporary users of electronic communications, such as conducted via text messaging, social media postings, virtual reality events, voice phone calls, video conferencing calls and/or the like often become involved in a conversation around a particular theme. For example, consider a group of users conversing about an event such as going out for a weekend evening. The users may have several general ideas. Generally one user takes the lead, does some research, comes up with some possible suggestions, and gets back to the other user or users. This can be inconvenient, biased by the likes and dislikes of the researching user, possibly involve lengthy travel for one or more of the users, and so forth.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram of an example system for monitoring communications to obtain search results relevant to a user group's conversation, in accordance with various aspects and embodiments of the subject disclosure.

FIGS. 2-6 are example system representations of user interfaces rendered on a user device for presenting search results relevant to content of a user conversation, in accordance with various aspects and embodiments of the subject disclosure.

FIGS. 7 and 8 are example system representations of user interfaces rendered on a user device for curating a list based on content of a user conversation, in accordance with various aspects and embodiments of the subject disclosure.

FIG. 9 is a block diagram of an example system and representation of a virtual reality environment in which communications can be monitored to obtain search results relevant to a user group's conversation, in accordance with various aspects and embodiments of the subject disclosure.

FIG. 10 is a representation of a virtual reality environment in which communications have been monitored to obtain search results relevant to a user group's conversation, in accordance with various aspects and embodiments of the subject disclosure.

FIG. 11 is a flow diagram representing example operations related to constructing a search query based on communications to present search result data, in accordance with various aspects and embodiments of the subject disclosure.

FIG. 12 is a flow diagram representing example operations related to monitoring a conversation between users of a user group to obtain and output search result data, in accordance with various aspects and embodiments of the subject disclosure.

FIG. 13 is a flow diagram representing example operations related to monitoring a conversation between users of a user group to obtain and output search result data via a virtual participant, in accordance with various aspects and embodiments of the subject disclosure.

FIG. 14 illustrates an example block diagram of an example mobile handset operable to engage in a system architecture that facilitates wireless communications according to one or more embodiments described herein.

FIG. 15 illustrates an example block diagram of an example computer/machine system operable to engage in a system architecture that facilitates wireless communications according to one or more embodiments described herein.

### DETAILED DESCRIPTION

The technology described herein is generally directed towards the automated detection of a conversation thread among two or more parties and the initiation of a search based on an analysis of the thread. Searching may be done iteratively and, therefore, iterate upon itself based on how the conversation progresses. The conversation thread may be within a messaging application, a social application, virtual reality application, synthesized from a voice conversation, or other.

The technology described herein thus provides a convenient and accurate way to assist a group of two or more users to arrive at results for a search request that a system may infer based on a conversation that takes place among the group members. The conversation also may be conducted in real time or over a length of time such that pieces of the conversation are non-contiguous in time. Real-time conversation platforms may include voice phone calls, video conferencing calls, or other.

Further, the search result data can be used in various ways, including presenting the search result data to the group. The search result data can be presented to the group in a selection (e.g., voting-like) format, whereby the group can arrive at a consensus as to which search result is favored by the group. The search result data can be saved, presented again at a later time, as well as used to modify the users' calendar application data. The search result data can be used to create a curation or a list of items related to a conversation thread.

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, can be utilized interchangeably in the application, and can refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “user equipment,” “device,” “communication device,” “mobile device,” “subscriber,” “customer entity,” “consumer,” “customer entity,” “entity” and the like may be employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth. Olfactory output as well as taste output and/or tactile output can also be part of a promotional presentation as described herein.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.11 wireless technologies and/or legacy telecommunication technologies.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

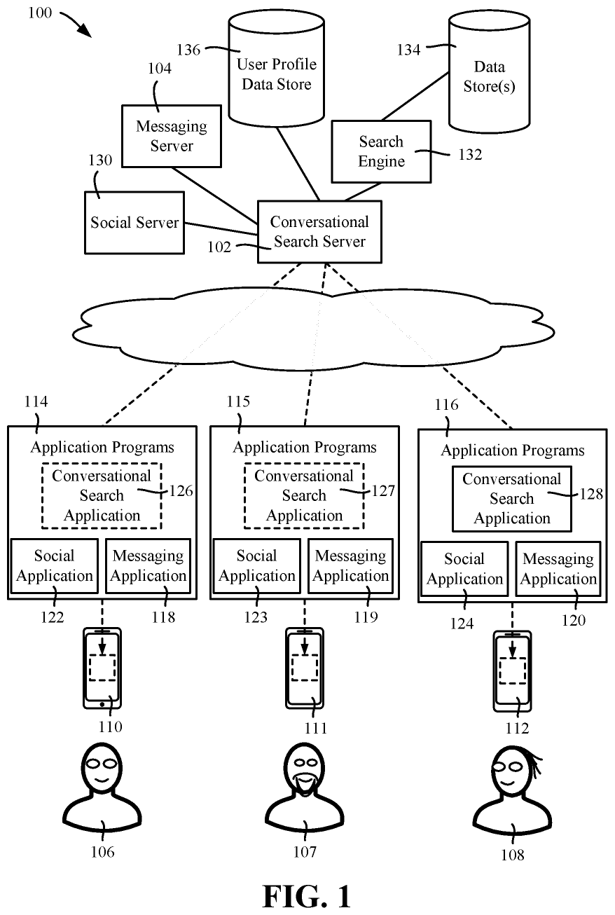

FIG. 1 shows an example system/architecture 100 including a conversational server 102, which monitors the conversations of users, such as conversations communicated between the users via a messaging server 104. The conversational search server is coupled to user devices.

More particularly, two or more users (three such users 106-108, with communications devices 110-112, respectively, are depicted in the example of FIG. 1) may each be equipped with application programs 114-116, respectively. The application programs 114-116 shown in the example of FIG. 1 include messaging application programs 118-120, respectively, social applications 122-124, respectively, or other conversational applications (not explicitly shown). A messaging application/server arrangement is used for this example. With no loss of generality, a single user (e.g., any of the users 106-108 also may have messaging applications 118-120 actively running and conveying conversational threads across multiple devices, like a mobile device, a desktop computer, a voice-based in-vehicle system, a smart watch, a smart television, and/or any other such device(s).

In addition, a conversational search application exists on at least one of the users' devices, such as the conversational search application 128. In this example, the conversational search application 128 is in communication with the conversational search server 102. This conversational application 128/server 102 exists between the messaging application program(s) and the messaging server 104 so as to monitor conversations and provide search services based on content of the conversations. Similarly, the conversational application 128/server 102 exists between the social application program(s) and the social (media) server 130. Note that in alternative implementations, a conversational search application can perform some or all of the monitoring, instead of or in conjunction with a conversational search server, to determine a search query and obtain search results.

At least one search engine 132 is coupled to the conversational search server 102 to obtain search requests obtained from monitoring conversations. The search engine(s) 132 are coupled to data store(s) 134 to obtain search result data, which is returned to the conversational search server 102 and thereby to the user devices 110-112 in this example.

Each user may have user profile data (e.g., in the user profile data store 136) that is accessible by the conversational search server 102. This profile data may include settings such as opt-in privacy settings for one or more users. For example, if a user sets his or her conversational search application to private, the conversational search server 102 does not monitor that user's contributions to any conversation for the purposes of creating a search request. Other members of those conversations may choose to opt-in for monitoring, however; (note that an indication such as a notification may be provided by the system so that the users being monitored are aware that the conversation is being monitored). Similarly, conversations from an opted-in user may be excluded or made generic if they mention or refer to conversations or attributes of an opted-out user; in one example, the specific school of the opted-out user is replaced with a generic word or token that represents all schools. Alternatively, a user may specify that their conversational search application may monitor their contributions to conversations, but only for conversations that include specific other members. Other settings are feasible; e.g., only monitor work conversations during working hours, only monitor friend conversations during out of work hours, and so on.

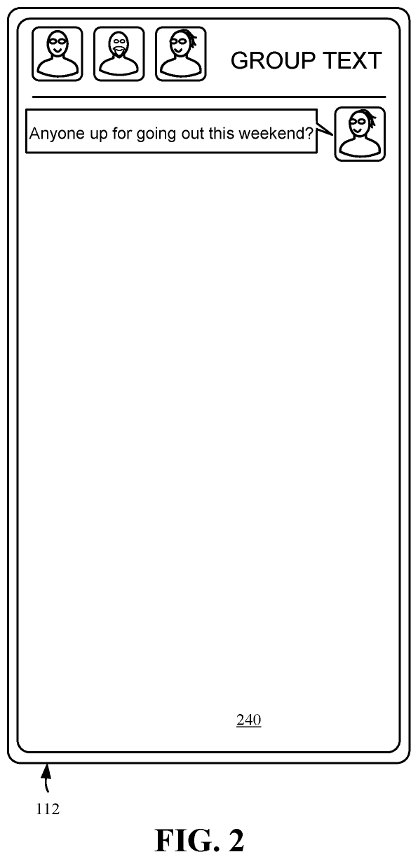

A conversation may be initiated by one of the users, e.g., the user 108, such as shown in FIG. 2 on the user interface 240 of the communications device 112. Initiation of the conversation and the indication of the other parties to be included in a conversation constitute the creation of a conversation thread, in general. In one example implementation, the messaging application (e.g., 120) communicates with the conversational search application (e.g., 128) to indicate the creation of a conversation thread. The creation of the conversation thread may be sent from the conversational search application 128 to the conversational search server 102, which directs it to the messaging server 104. Thus, the conversational search application 128 and conversational search server 102 can act as a pass-through, as well as a monitoring mechanism for communications that contribute to the conversation thread.

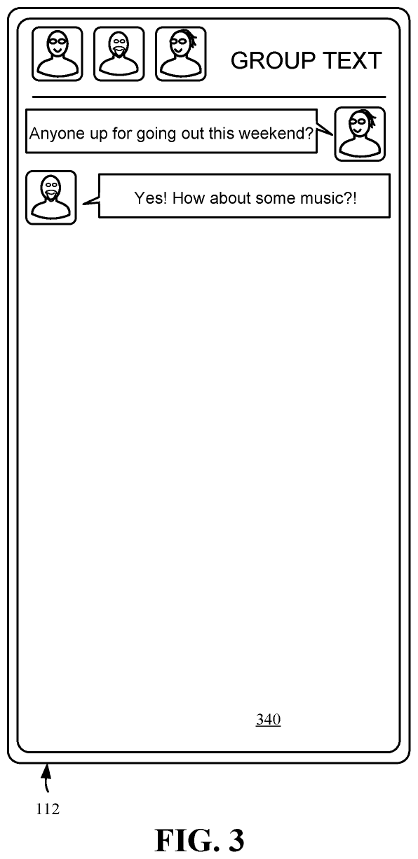

As a messaging conversation progresses, e.g., as shown in the updated user interface 340 of FIG. 3 where the user 107 contributes to the conversation, the thread progresses and more information is contributed to the overall content and context of the conversation. For any members of the conversation that have opted in, the conversational search server 102 may continually monitor their contributions to the conversation. The conversational search server 102 may conduct, overtime, using artificial intelligence/machine learning techniques or the like, and/or other analysis of the conversation, the conversation's intent. Further, any questions that may be implied by the content of the conversation that may imply the need for the benefit of a search request are likewise determined. In the example shown in FIG. 2, the conversational search server 102 may infer that the conversation may benefit from a search for a listing of nearby music events this weekend. For example, a listing service may be triggered by keyword spotting (e.g. “suggest,” “options,” etc. may indicate a query for knowledge), a conversation comment posed as a question (e.g. “going out this weekend?”), or an anomalous delay in the conversation's cadence (e.g. after “music is good” a duration of minutes passes whereas previously comments were added within ten seconds). The conversational search server 102 may receive other data, such as from the users' devices, or their user profiles, which may assist in the creation of a search request. For example, location information for each of the users may be obtained from their devices and used to facilitate the formation of a search request in this example.

Upon inferring what is understood by the conversational search server 102 to be a useful search query, the conversational search server 102 constructs a query for the search engine 132 of FIG. 1 (or other search application). The context of the search request may be optionally used by the conversational search server 102 to determine a best destination for which search engine and/or other search application to use. For example, in this example a search is deemed requested for music events, and as such the search may be directed to an appropriate search engine or application for such events.

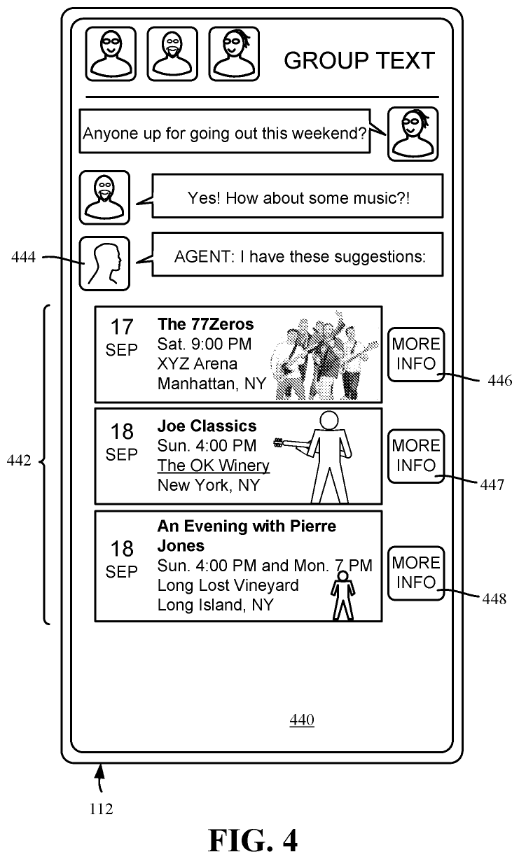

The results of the search request may be returned to the conversational search server 102. As shown in FIG. 4 via the updated user interface 440 of the device 112, the search result data 442 may be presented as a part of the conversation, such as via a virtual agent 444 now participating in the conversation and presenting the search results. The search result data 442 may include links such that the search results are active and may be selected to request additional information. This can be via the “MORE INFO” buttons 446-448. A link may also be in the result data itself, as depicted by the underlined “The OK Winery” for example, which, if selected, can link to the winery's website, directions, or any appropriate suitable site. With no loss of generality, the messages comprising the search result data may utilize an output format or messaging protocol that is interoperable between mobile service providers (e.g., SMS, short messaging service, MMS, multimedia messaging service respectively, RCS, Rich Communication Services), or one or more that is/are proprietary to a platform (e.g., well-known messaging applications belonging to technology companies, etc.).

It should be noted that the virtual agent or the like can be part of the conversation before presenting any search results. For example, such as when notifying the opted-in users that their conversation is being monitored, the agent may be presented as a participant, e.g., “I am your virtual agent, monitoring your conversation so as to answer questions and otherwise assist you.” This can be by an appropriate output, e.g., text, a social media posting, voice, graphics, an image or video, via a virtual reality participant, and the like. Further, the virtual agent also may prompt only the opt-in users to add contributions to the conversation before they are broadly shared to both opt-in and opt-out members as a means of introducing a potential response before it is distributed.

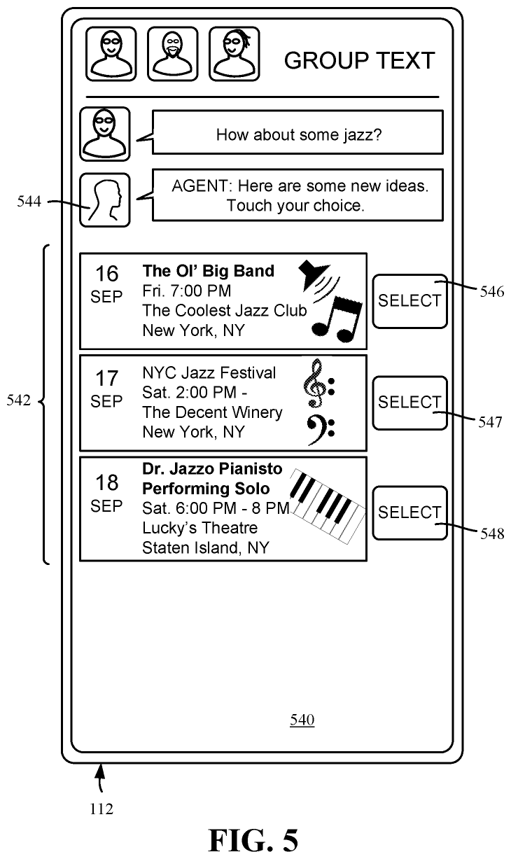

As the conversation continues, the conversational search server 102 may retain memory of the elements of the conversational history, at least those that are deemed relevant, and may create new searches based on new content added by members of the conversation. For example, in FIG. 5 the user 106 (FIG. 1) adds to the conversation by inquiring “How about some jazz?” This new content may be used in various ways, including to filter prior search results or to conduct a new search that is created based on the new content as well as the historical content within the conversation. In this example, the music-related search query of FIG. 4 is filtered to now search for weekend music events with a jazz theme. The results are then updated on the updated user interface 540 to present the updated search result data 542 related to upcoming jazz events.

As described herein, the conversational search server 102 (FIG. 1) may present selectable links for the one or more items that are returned as a result of the search. The selectable links may provide additional information about each of the results, or optionally may serve the purpose of providing each member of the conversation to select one or more of their preferred search results. In the example of FIG. 5, three selection interactive elements 546-548 are depicted, by which the conversation participants can vote to determine a group selection.

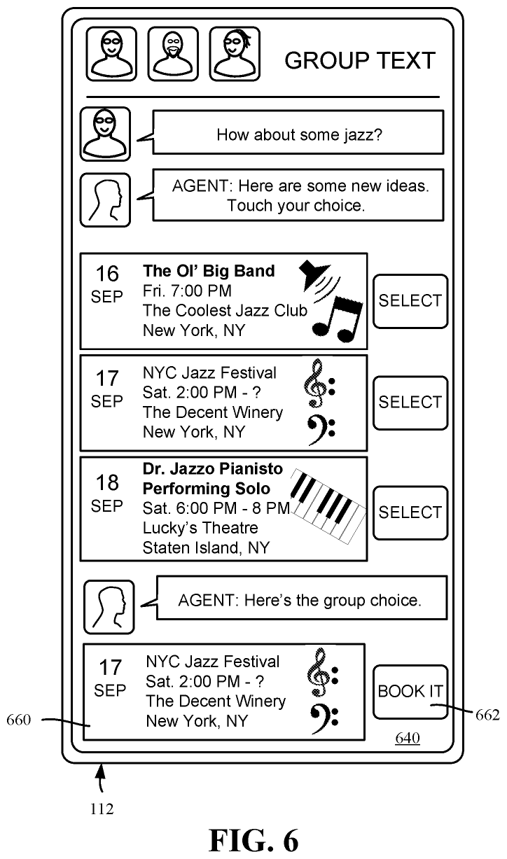

In this manner, the conversational search server may serve to collect input from each of the members to determine a collective group preferred search result, as shown in FIG. 6 via the output 660 rendered on the updated user interface 640 in this example. The members of the conversation may select to take an action based on the group's preferred search results, such as to make a purchase, make a reservation (e.g., via the “BOOK IT” interactive element 662), save a result, create a calendar entry, send out invitations, or other. Note that ties can be resolved by a tiebreaking mechanism, or multiple choices can be presented to the user group with an indication that there was a tie so that the group can further decide.

It should be noted that many conversations can be joined by a user at any time, even after other users generally consider the conversation finished. For example, consider a text message conversation among a group; if a user is unable to participate in the initial text message conversation, and reads the text thread later, the later-joining user can add to the conversation thread, which the other users will see. The system can update the search results based on the new content. Similarly, the search results may be derived not only from the instantaneous conversation text (e.g. “how about some jazz?”) but also the historical preferences and behaviors of those other users in the conversation thread; (e.g. Claire always like Salsa dancing when in the company of Mary but prefers ballroom dancing when in the company of Fred).

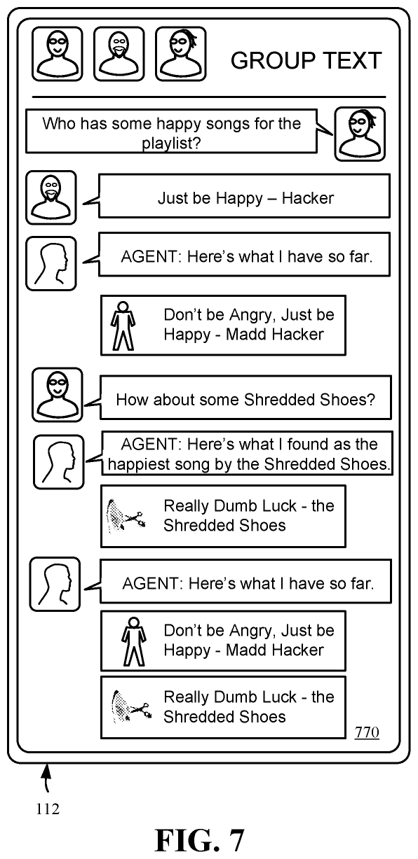

In another embodiment, this technology described herein may be used to monitor a group conversation for the purpose of creating a curation or a list of items. By way of example, the user interface 770 of FIG. 7 shows how a curated list may be formed via a collection of direct inputs from one or more of the users as well as search results from the conversation. In this example, a playlist is being built from user input and search result data.

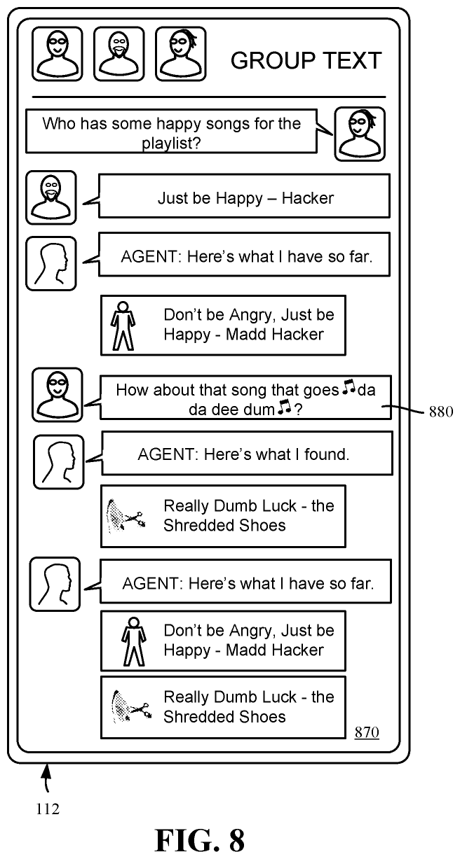

FIG. 8 is similar to FIG. 7, however in this user interface 870 input is entered by a combination of text, spoken input, or other audio input. Input also may be via image or video. Examples of visual input may include a likeness of an artist, an album cover, movie poster, movie clip, color theme, desired location, or a thematic environment (like a sunset). As an example of other audio input, as part of audio (or text) input 880 representing speech, a user may hum a few notes of a song; the conversational search server 102 may send it to a search engine that is capable of matching notes/a melody to identify a piece of music. Input also may be a digital transaction or other historical log that has secondary image, text, or audio events included in its event definition (e.g. a ticket to a movie or performance may include subsequent lists of featured music and images).

Any search result data can be saved by the system for later presentation to one or more of the users. Information obtained via search result data also can be saved to a calendar application as calendar data. Thus, for example, if the users are discussing weekend plans early in the week, the users can interact with the system (e.g., via their conversational search applications) to recall their conversation(s) and review their plan(s). Recalled search result data can be updated at the time of recall; for example, if an event date has passed, or an event is canceled, the search result data can be made current based on this updated information.

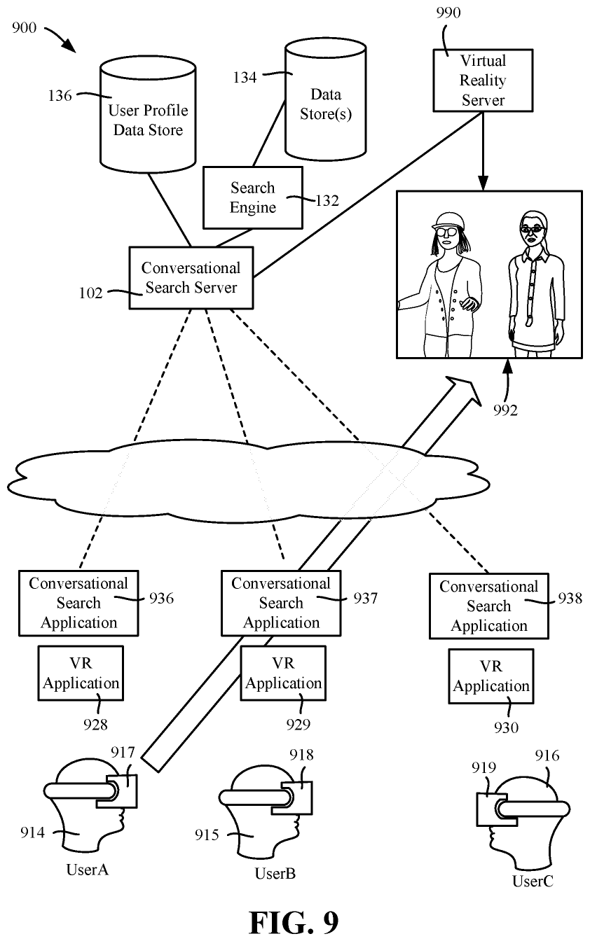

Turning to another example, in a similar way, a conversation thread may be inferred based on an ad hoc determination, as opposed to the explicit establishment of a thread. For example, as shown in the example system/architecture 900 of FIG. 9, the conversational server 102 can be coupled to a virtual reality (VR) server 990 that generates a virtual reality environment 992. In this virtual reality environment 992, when a group of two or more users are within a proximate location of each other, conversational input from them, whether it be text, or spoken, or other input, may be interpreted to be related to a conversation amongst the members of a group that are within a proximate area.

In FIG. 9, three users 914-916 (UserA, UserB and UserC) are shown, with virtual reality headsets 917-919, respectively. In the example of FIG. 9, the respective users 914-916 have, via communications devices (not explicitly shown, which may be incorporated into a headset and/or devices coupled thereto) respective running instances of a virtual reality (VR) application 928-930, and respective conversational search applications 936-938. These users may exist within the same virtual reality environment 992, e.g., as being experienced from UserA's perspective.

The conversational search server 102 (FIG. 9) may receive information from the virtual reality server 990 or user profile data (in data store 136) related to the location of each of the users 914-916. If the users 914-916 are determined to be within a range of each other, the conversational search server 102 may declare the creation of a conversational thread.

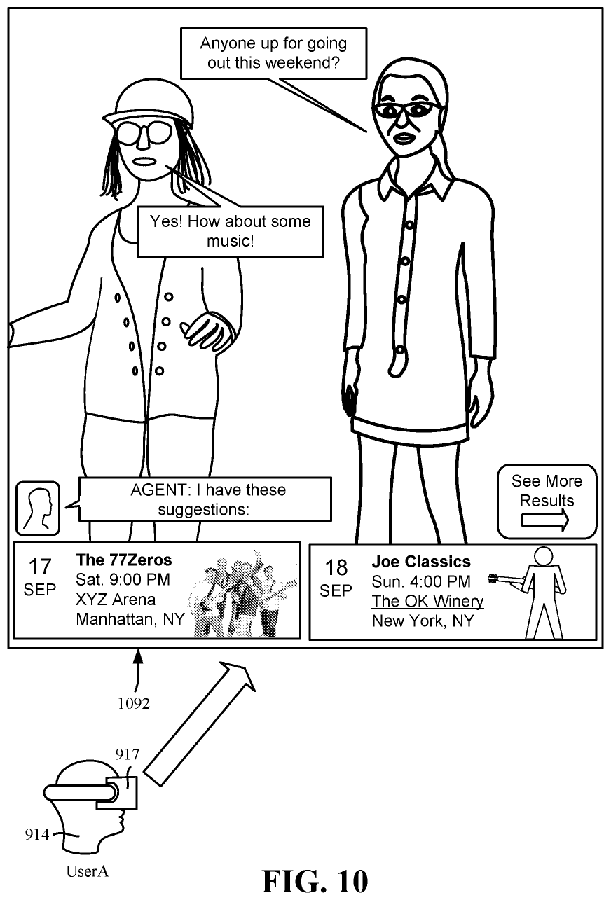

From there, as generally represented in FIG. 10, the system/architecture 900 supports generally acts in the same way as described herein. The search result data obtained in FIG. 10 is generally similar to FIG. 4, e.g., overlaid (in part) over the updated virtual reality environment 1090.

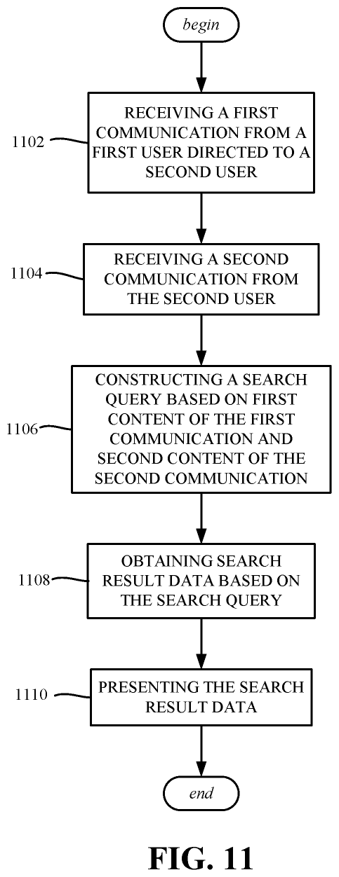

One or more example aspects are represented in FIG. 11, and can correspond to a system, including a processor, and a memory that stores executable instructions that, when executed by the processor, facilitate performance of operations. Example operation 1102 represents receiving a first communication from a first user directed to a second user. Example operation 1104 represents receiving a second communication from the second user. Example operation 1106 represents constructing a search query based on first content of the first communication and second content of the second communication. Example operation 1108 represents obtaining search result data based on the search query. Example operation 1110 represents presenting the search result data.

The search query can be a first search query, the search result data can include first search result data, and further operations can include receiving a third communication, altering the first search query into a second search query based on content of the third communication, obtaining second search result data based on the second search query, and presenting the second search result data. Altering the first search query into the second search query can include filtering the first search query based on the content of the third communication.

The search query can be a first search query, the search result data can include first search result data, and further operations can include receiving filtering the first search result data based on the third communication to obtained modified search result data.

The search query can be a first search query, the search result data can include first search result data, and further operations can include receiving a third communication from a third user, receiving a fourth communication, obtaining opt-out data from the third user, altering the first search query into a second search query based on content of the fourth communication while excluding content of the third communication, obtaining second search result data based on the second search query, and presenting the second search result data.

Presenting the second search result data can include outputting the search result data to the first user and the second user; further operations can include receiving a selection of a selected search result collectively chosen by the first user and the second user from among the search result data as presented, and presenting the selected search result as a chosen result.

Further operations can include detecting a conversation thread based on the first communication and the second communication. Presenting the search result data can include outputting the search result data via a virtual agent that joins the conversation thread.

Further operations can include receiving outputting an indication indicating that the first communication and the second communication are part of a monitored conversation.

Constructing the search query further can include supplementing the search query based on at least one of: first user profile data of the first user, or second user profile data of the second user.

Constructing the search query further can include supplementing the search query based on at least one of: first location information of the first user, or second location information of the second user.

Further operations can include receiving maintaining information based on the search result data.

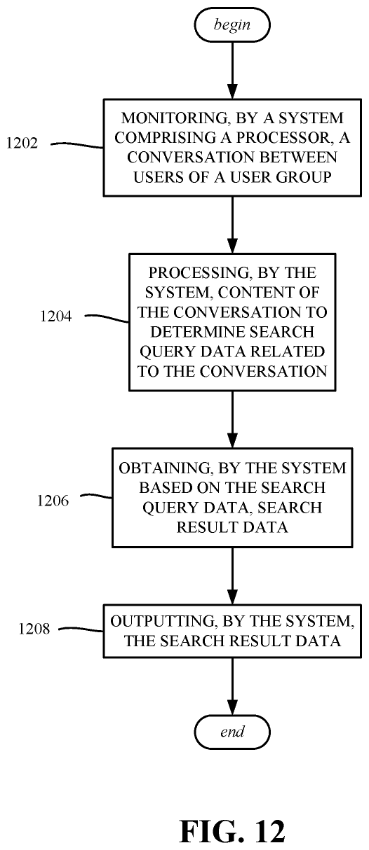

One or more example aspects are represented in FIG. 12, and, for example, can correspond to operations, such as of a method. Example operation 1202 represents monitoring, by a system comprising a processor, a conversation between users of a user group. Example operation 1204 represents processing, by the system, content of the conversation to determine search query data related to the conversation. Example operation 1206 represents obtaining, by the system based on the search query data, search result data. Example operation 1208 represents outputting, by the system, the search result data.

Outputting the search result data can include presenting the search result data to at least one user of the group during the conversation.

Outputting the search result data can include maintaining the search result data for subsequent retrieval.

Further operations can include obtaining privacy data associated with a user of the user group that indicates that communications of the user are not to be monitored, and based on the privacy data, excluding the communications of the user from the processing of the content of the conversation.

Further operations can include obtaining privacy data associated with a user of the user group that indicates that communications of the user are not to be monitored unless the user group is an approved group, and based on the obtaining of the privacy data, determining whether the user group is an approved group, and, in response to the user group being an approved group, including the communications of the user in the processing of the content of the conversation, and, in response to the user group not being an approved group, excluding the communications of the user from the processing of the content of the conversation.

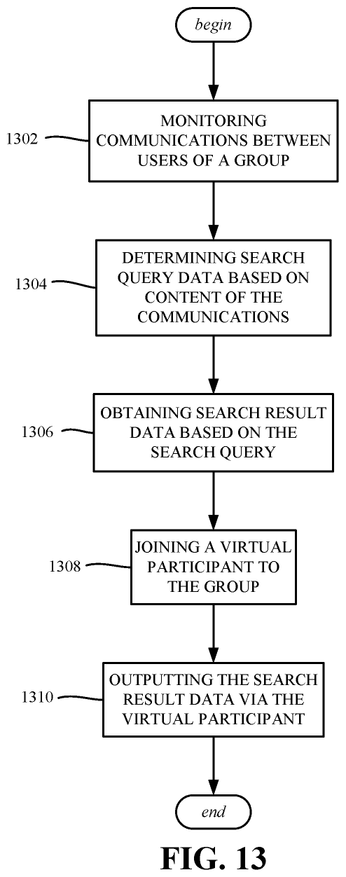

One or more aspects are represented in FIG. 13, such as implemented in a machine-readable medium, including executable instructions that, when executed by a processor, facilitate performance of operations. Example operation 1302 represents monitoring communications between users of a group. Example operation 1304 represents determining search query data based on content of the communications. Example operation 1306 represents obtaining search result data based on the search query. Example operation 1308 represents joining a virtual participant to the group. Example operation 130 represents outputting the search result data via the virtual participant.

The search result data can include multiple options; further operations can include obtaining a consensus result from the users of the group with respect to an option of the multiple options, and outputting the consensus result via the virtual participant.

Obtaining the search result data can include monitoring subsequent communications between the users of the group, and altering the search result data based on the subsequent communications.

As can be seen, the technology described herein facilitates a convenient and accurate way to assist a group of users in arriving at desired results corresponding to a search request. By monitoring a conversation that takes place among group members, a relevant search query can be implied and constructed, with search result data obtained based on the search query and presented to the members.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (including both open-loop and closed-loop), beamforming, and codebook-based precoding can also be used to address issues such as efficiency, interference, and range.

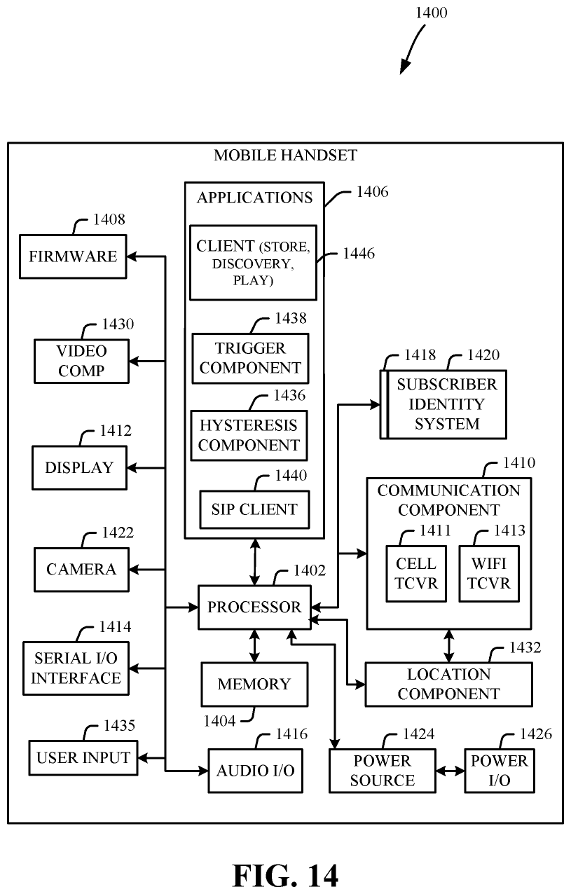

Referring now to FIG. 14, illustrated is a schematic block diagram of an example end-user device (such as user equipment) that can be a mobile device 1400 capable of connecting to a network in accordance with some embodiments described herein. Although a mobile handset 1400 is illustrated herein, it will be understood that other devices can be a mobile device, and that the mobile handset 1400 is merely illustrated to provide context for the embodiments of the various embodiments described herein. The following discussion is intended to provide a brief, general description of an example of a suitable environment 1400 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1400 includes a processor 1402 for controlling and processing all onboard operations and functions. A memory 1404 interfaces to the processor 1402 for storage of data and one or more applications 1406 (e.g., a video player software, user feedback component software, etc.). Other applications can include voice recognition of predetermined voice commands that facilitate initiation of the user feedback signals. The applications 1406 can be stored in the memory 1404 and/or in a firmware 1408, and executed by the processor 1402 from either or both the memory 1404 or/and the firmware 1408. The firmware 1408 can also store startup code for execution in initializing the handset 1400. A communications component 1410 interfaces to the processor 1402 to facilitate wired/wireless communication with external systems, e.g., cellular networks, VoIP networks, and so on. Here, the communications component 1410 can also include a suitable cellular transceiver 1411 (e.g., a GSM transceiver) and/or an unlicensed transceiver 1413 (e.g., Wi-Fi, WiMax) for corresponding signal communications. The handset 1400 can be a device such as a cellular telephone, a PDA with mobile communications capabilities, and messaging-centric devices. The communications component 1410 also facilitates communications reception from terrestrial radio networks (e.g., broadcast), digital satellite radio networks, and Internet-based radio services networks.

The handset 1400 includes a display 1412 for displaying text, images, video, telephony functions (e.g., a Caller ID function), setup functions, and for user input. For example, the display 1412 can also be referred to as a “screen” that can accommodate the presentation of multimedia content (e.g., music metadata, messages, wallpaper, graphics, etc.). The display 1412 can also display videos and can facilitate the generation, editing and sharing of video quotes. A serial I/O interface 1414 is provided in communication with the processor 1402 to facilitate wired and/or wireless serial communications (e.g., USB, and/or IEEE 1494) through a hardwire connection, and other serial input devices (e.g., a keyboard, keypad, and mouse). This supports updating and troubleshooting the handset 1400, for example. Audio capabilities are provided with an audio I/O component 1416, which can include a speaker for the output of audio signals related to, for example, indication that the user pressed the proper key or key combination to initiate the user feedback signal. The audio I/O component 1416 also facilitates the input of audio signals through a microphone to record data and/or telephony voice data, and for inputting voice signals for telephone conversations.

The handset 1400 can include a slot interface 1418 for accommodating a SIC (Subscriber Identity Component) in the form factor of a card Subscriber Identity Module (SIM) or universal SIM 1420, and interfacing the SIM card 1420 with the processor 1402. However, it is to be appreciated that the SIM card 1420 can be manufactured into the handset 1400, and updated by downloading data and software.

The handset 1400 can process IP data traffic through the communication component 1410 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1422 (e.g., a camera) can be provided for decoding encoded multimedia content. The video processing component 1422 can aid in facilitating the generation, editing and sharing of video quotes. The handset 1400 also includes a power source 1424 in the form of batteries and/or an AC power subsystem, which power source 1424 can interface to an external power system or charging equipment (not shown) by a power I/O component 1426.

The handset 1400 can also include a video component 1430 for processing video content received and, for recording and transmitting video content. For example, the video component 1430 can facilitate the generation, editing and sharing of video quotes. A location tracking component 1432 facilitates geographically locating the handset 1400. As described hereinabove, this can occur when the user initiates the feedback signal automatically or manually. A user input component 1434 facilitates the user initiating the quality feedback signal. The user input component 1434 can also facilitate the generation, editing and sharing of video quotes. The user input component 1434 can include such conventional input device technologies such as a keypad, keyboard, mouse, stylus pen, and/or touch screen, for example.

Referring again to the applications 1406, a hysteresis component 1436 facilitates the analysis and processing of hysteresis data, which is utilized to determine when to associate with the access point. A software trigger component 1438 can be provided that facilitates triggering of the hysteresis component 1438 when the Wi-Fi transceiver 1413 detects the beacon of the access point. A SIP client 1440 enables the handset 1400 to support SIP protocols and register the subscriber with the SIP registrar server. The applications 1406 can also include a client 1442 that provides at least the capability of discovery, play and store of multimedia content, for example, music.

The handset 1400, as indicated above related to the communications component 810, includes an indoor network radio transceiver 1413 (e.g., Wi-Fi transceiver). This function supports the indoor radio link, such as IEEE 802.11, for the dual-mode GSM handset 1400. The handset 1400 can accommodate at least satellite radio services through a handset that can combine wireless voice and digital radio chipsets into a single handheld device.

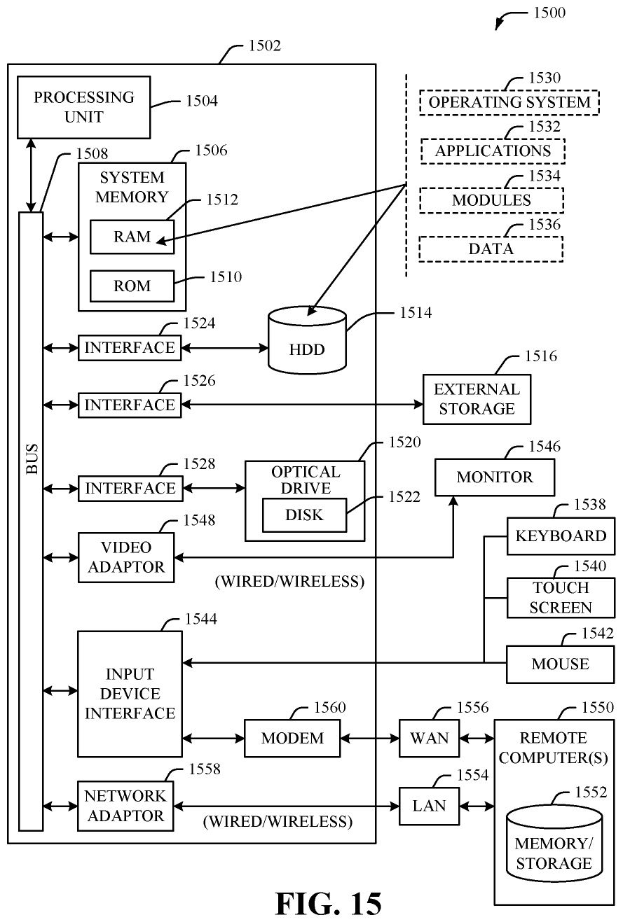

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid state drive (SSD), non-volatile memory and other storage technology could be used in addition to, or in place of, an HDD 1514, and can be internal or external. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1494 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally include emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can include one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1494 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 15 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A system, comprising:
a processor; and
a memory that stores executable instructions that, when executed by the processor of the system, facilitate performance of operations, the operations comprising:
receiving a first communication from a first user directed to a second user;
receiving a second communication from the second user;
constructing a search query based on first content of the first communication and second content of the second communication;
obtaining search result data based on the search query; and
presenting the search result data.

2. The system of claim 1, wherein the search query is a first search query, wherein the search result data are first search result data, and wherein the operations further comprise receiving a third communication, altering the first search query into a second search query based on content of the third communication, obtaining second search result data based on the second search query, and presenting the second search result data.

3. The system of claim 2, wherein the altering of the first search query into the second search query comprises filtering the first search query based on the content of the third communication.

4. The system of claim 1, wherein the search query is a first search query, wherein the search result data are first search result data, and wherein the operations further comprise filtering the first search result data based on the third communication to obtained modified search result data.

5. The system of claim 1, wherein the search query is a first search query, wherein the search result data are first search result data, and wherein the operations further comprise receiving a third communication from a third user, receiving a fourth communication, obtaining opt-out data from the third user, altering the first search query into a second search query based on content of the fourth communication while excluding content of the third communication, obtaining second search result data based on the second search query, and presenting the second search result data.

6. The system of claim 1, wherein the presenting of the search result data comprises outputting the search result data to the first user and the second user, and wherein the operations further comprise receiving a selection of a selected search result collectively chosen by the first user and the second user from among the search result data as presented, and presenting the selected search result as a chosen result.

7. The system of claim 1, wherein the operations further comprise detecting a conversation thread based on the first communication and the second communication.

8. The system of claim 7, wherein the presenting of the search result data comprises outputting the search result data via a virtual agent that joins the conversation thread.

9. The system of claim 1, wherein the operations further comprise outputting an indication indicating that the first communication and the second communication are part of a monitored conversation.

10. The system of claim 1, wherein the constructing of the search query further comprises supplementing the search query based on at least one of: first user profile data of the first user, or second user profile data of the second user.

11. The system of claim 1, wherein the constructing of the search query further comprises supplementing the search query based on at least one of: first location information of the first user, or second location information of the second user.

12. The system of claim 1, wherein the operations further comprise maintaining information based on the search result data.

13. A method, comprising:
monitoring, by a system comprising a processor, a conversation between users of a user group;
processing, by the system, content of the conversation to determine search query data related to the conversation;
obtaining, by the system based on the search query data, search result data; and
outputting, by the system, the search result data.

14. The method of claim 13, wherein the outputting of the search result data comprises presenting the search result data to at least one user of the group during the conversation.

15. The method of claim 13, wherein the outputting of the search result data comprises maintaining the search result data for subsequent retrieval.

16. The method of claim 13, further comprising obtaining privacy data associated with a user of the user group that indicates that communications of the user are not to be monitored, and based on the privacy data, excluding the communications of the user from the processing of the content of the conversation.

17. The method of claim 13, further comprising obtaining privacy data associated with a user of the user group that indicates that communications of the user are not to be monitored unless the user group is an approved group, and based on the obtaining of the privacy data, determining whether the user group is an approved group, and, in response to the user group being an approved group, including the communications of the user in the processing of the content of the conversation, and, in response to the user group not being an approved group, excluding the communications of the user from the processing of the content of the conversation.

18. A non-transitory machine-readable medium, comprising executable instructions that, when executed by a processor, facilitate performance of operations, the operations comprising:
monitoring communications between users of a group;
determining search query data based on content of the communications;
obtaining search result data based on the search query;
joining a virtual participant to the group; and
outputting the search result data via the virtual participant.

19. The non-transitory machine-readable medium of claim 18, wherein the search result data comprises multiple options, and wherein the operations further comprise obtaining a consensus result from the users of the group with respect to an option of the multiple options, and outputting the consensus result via the virtual participant.

20. The non-transitory machine-readable medium of claim 18, wherein the obtaining of the search result data comprises monitoring subsequent communications between the users of the group, and altering the search result data based on the subsequent communications.
